(19) United States
(12) Patent Application Publication
(10) Pub. No.: US 2004/0243026 A1
(43) Pub. Date: Dec. 2, 2004

(54) Thermal applicator and application system

(76) Inventors: Joerg Toepfer, Jena (DE); Konrad Boegelein, Neu-Ulm (DE)

Correspondence Address: NIXON & VANDERHYE, PC, 1100 N GLEBE ROAD, 8TH FLOOR, ARLINGTON, VA, 22201-4714, US

(21) Appl. No.: 10/484,629

(22) PCT Filed: Jul. 25, 2002
(86) PCT No.: PCT/EP02/08302

(30) Foreign Application Priority Data
Jul. 25, 2001 (CH) 1390/01

(51) Int. Cl. A61H 23/00

(52) U.S. Cl. 601/15; 601/16; 601/151

(57) ABSTRACT

An applicator (11a-g) for the surface application of a gaseous medium to a part of the body of a living human or animal organism, comprising a gas passage side (21) provided with a plurality of through openings (22) oriented towards the part of the body to be treated during application. A device (13) is also provided for supplying a gas or gas mixture to or onto the gas passage (21), embodied in such a way that at least a part of the gas supplied during operation of the applicator flows through the through openings (22) of the gas passage side (21). A three-dimensional structure (15) is provided on the gas passage side (21) to enable the gas to be finely distributed parallel to the gas passage side (21), whereby the medium flowing out of the gas passage side (21) has an even temperature and volume distribution.

The invention relates to an applicator and an applicator system for the production and application of a stream of a cold and/or warm gaseous medium to a body or a part of a body that has to be treated.

It was already known in antiquity that pain could be attenuated by being treated with cold (so-called cryotherapy). In modern times treatment with cold air is used not only for treating pain, but for example also for the treatment of acute or chronic diseases of the human supporting and locomotor system.

Known to prior art are, among others, appliances for cold air therapy by means of which environmental air is sucked up, cooled and then released again via a hose. A drawback associated with these instruments is that the opening of the hose has to be guided manually over the body part or area that is to be treated. Consequently, the distance between the opening of the hose and the body part to be treated, the distribution of the released quantity of air, the angle at which the air strikes the body and the thermodynamic effect are subject to substantial variations. This means that it is not readily possible to monitor (supervise), quantify, differentiate and control the application and the place of the application. Yet another disadvantage is that the part of the body is in contact with the support and cannot therefore be reached in a circular manner. The fact that appropriate personnel is required for the duration of the therapy constitutes yet another disadvantage.

U.S. Pat. No. 5,214,860 discloses a gypsum-drying device that is used in combination with compressed air. The gypsum-drying device comprises an inflatable bladder with an inner and an outer wall that are welded to each other and define an expansion chamber. The expansion chamber is provided with one or more openings for letting air enter into the chamber. Furthermore, the inner wall is provided with a plurality of air outlet openings. U.S. Pat. No. 5,214,860 further suggests the use of an essentially flat bladder and to apply the bladder to the gypsum in such a manner as to enable an even air stream to penetrate into the various parts of the gypsum.

DE-OS-34 14 094 relates to an installation for the treatment of thermal injuries. The installation comprises a blower, a filter system, an electric heater and a control unit, complete with a temperature setting device, connected to the heater, as well as a device for conveying bacteria-free air into a treatment chamber. The treatment chamber is a transparent bag that can be elastically blown up by the air stream.

U.S. Pat. No. 5,983,693 discloses a therapeutic system with a generator for the production of a stream of warmed and moist air for facial treatments. The generator has a housing with a vapour chamber and a liquid reservoir. The fluid present in the liquid reservoir can be heated by heating means, the vapour produced in this manner being accommodated in the vapour chamber. An interface connected to the generator makes it possible for the moist and heated air to be directed onto a desired treatment surface. The interface preferably has the form of a mask with an inner and an outer lining. The inner lining consists of a textile active for breathing purposes, a microporous membrane for example, with a certain first permeability. The outer lining has a certain second permeability, which is smaller than the permeability of the inner wall. Furthermore, the interface may have the form of a cushion that can be attached to certain parts of the body by means of straps provided on the cushion.

The interface of U.S. Pat. No. 5,938,693 is simple and advantageous. Nevertheless, it is difficult to maintain an even temperature over the entire surface of the interface during operation, because the heated air is conveyed only to a single position. U.S. Pat. No. 5,938,693 therefore suggests that appropriate channels should be provided in the inner lining in order to deflect the moist air in the desired manner. The interface of U.S. Pat. No. 5,938,693 is also associated with the danger that the inner and the outer lining will be pressed against each other, so that all gas flow will be interrupted in these positions. Consequently, practically no gas can issue from these positions.

It is therefore the object of the present invention to propose a device by means of which these drawbacks can be substantially avoided. It is particularly an object of the invention to make available an applicator and/or an applicator system that make possible better control and supervision, quantification, differentiability and reproducibility of the application and the place of application. A further aim is to propose additional uses of cold air therapy and/or “air change application”. Yet another object is to obtain the most even possible distribution and temperature of the applied stream of the medium.

### Description

According to the invention, an applicator in accordance with the preamble of claim 1 is characterized in that the means through which the gas passes is a three-dimensional structure that assures a fine distribution of the gas. The structure assures an even distribution of the gaseous medium before the medium, passing through the openings on the gas passage side, reaches the part of the body that is to be treated. Preferably, the three-dimensional structure is a three-dimensional woven or knitted spacer fabric, although in basic principle a nonwoven fabric or a felt could also be used. The advantage of a nonwoven material, felt or woven or knitted fabric consists of their air-guiding and air-distributing function. Consequently, it is possible to obtain a high degree of evenness of the temperature distribution and the volume flow of the gaseous medium. In operation, the three-dimensional structure assures gas distribution both parallel to the gas passage surface and at right angles thereto. The gas can be made to issue from the structure in all directions, but is preferably made to issue from the side of the applicator that faces the body. When the three-dimensional woven or knitted spacer fabric is made from a material capable of absorbing or removing (draining) moisture, the material may also offer the possibility of exploiting a direction-dependent (asymmetric) moisture conductance. This proves to be specially advantageous with applications in which the temperature is made to change. Suitable materials are such fibres with moisture-absorbing or moisture-supplying properties as, for example, cotton or viscous fibres.

Advantageously, the device for supplying a gas will define at least one distribution space with a plurality of outlet openings. The distribution space may be designed as a hose, a tube, a bag or something similar. Preferably, the at least one distribution space will be situated in the region of the surface constituted by the gas passage means. This has the advantage that the gas can be applied as a laminar flow distributed over the applicator surface. According to a preferred embodiment, there is provided a plurality of gas distribution spaces arranged at a certain distance from each other.

Advantageously, the at least one distribution space has a plurality of outlet openings. The plurality of outlet openings assures a coarse (rough) distribution of the gas introduced into the applicator, so that there is less danger that a temperature gradient will be constituted across the application surface. Although the outlet openings may be distributed over the entire circumference of the distribution space, according to a preferred embodiment they are provided only along an oblong section thereof. The distribution space can then be arranged in or on the three-dimensional woven fabric in such a manner as to have the gas outlet openings at least partially oriented in the direction of the gas passage side.

Advantageously, the applicator is designed to be flexible, so that the applicator can be made to match various parts of the body or be placed against them. The gas supply device, for example one or more hoses or cushions, can be arrange in or on the three-dimensional structure. One can therefore imagine embodiments in which gas distribution hoses or chambers are directly integrated into the three-dimensional structure.

In an advantageous embodiment the applicator is provided with a second side opposite to the first gas passage side that is not permeable for gases and the distribution spaces are arranged between the first and the second side. Such an applicator has the advantage that the gas can essentially issue only from the gas passage side. The applicator may be designed both as a single or a multi-layer system. Preferably, the exist openings will be arranged at some distance from the gas passage side of the three-dimensional structure. This has the advantage of making it possible to obtain a good and finely divided distribution of the medium flowing through the exist openings. Furthermore, guide surfaces may be provided in the distribution space to orient the issuing gas medium in the direction of the first layer during operation.

Advantageously the applicator will be provided with fixing means for attaching the applicator to or above the part of the body that is to be treated. The fixing means may be, for example, a strap, a belt or similar and may be integral with the applicator. Advantageously, the fixing means will have a Velcro fastener or similar, so that the applicator can be fixed to a part of the body.

The applicator can be made available in various embodiments, for example, as a cushion or a sleeve. The applicator may be provided with at least one window to render possible a treatment with, for example, a laser beam. The light treatment may be carried out either simultaneously with the treatment with the warm or the cold air or at some different time. The window may also be a cut-out in the three-dimensional structure that is covered, for example, by glass or a transparent plastic. The applicator may be provided with one or more connection lines that connect it to a heating and/or cooling device.

Another object of the present invention is an applicator system with at least one heating and/or cooling device for producing a heated or cooled gaseous medium and an applicator in accordance with any one of claims 1 to 18 and, as and when necessary, a connection means for connecting the cooling/heating device to the applicator. A preferred embodiment envisages the applicator system being provided with an applicator in accordance with any one of claims 1 to 18 and a cooling device for the production of a gaseous medium flow with a temperature below the normal environmental temperature and especially less than 10° C.

The applicator and/or the applicator system may be utilized for the controlled distribution and/or dosage of cold air or cold and/or warm air or warmth to limited surfaces and/or volumes in the case of all illnesses and conditions that are either directly or indirectly connected with spastics, oedemas, circulatory problems, as well as variations of the tension, length, structural, biomechanical, neurogenous, metabolic and viscous characteristics in the cellular, histological, organic, genetic and physiological area, especially of the musculature, the ligaments, the bones and the vascular and nervous system of living beings. Advantageously, the applicator system may be used for the treatment of circulatory problems in the cardiac-circulatory system. A further application concerns the use of the applicator in accordance with the invention for mobilizing the muscular and neuromuscular sector and the respiration and improving their performance. One can also imagine the applicator being used for the positive stimulation of the immune system and the psycho-vegetative system.

Its application leads to a mobilization and performance improvement of the neuromuscular system and the vascular system, as also to a favourable conditioning and/or improvement of the biomechanical, neuro-physiological and metabolic qualities of the musculature and the ligaments, the entire supporting and locomotor system, inclusive of all other histological structures. A positive influence is exerted on the hormonal, endocrinal, circulatory and microcirculatory aspects of the body and/or the body area. The criteria for the prevention and/or elimination of oedemas are also positive influenced. The haemodynamic, viscous and circulatory aspects of the body fluids are improved.

The invention will now be illustrated in greater detail by the description of embodiments thereof, the description making reference to the figures, of which

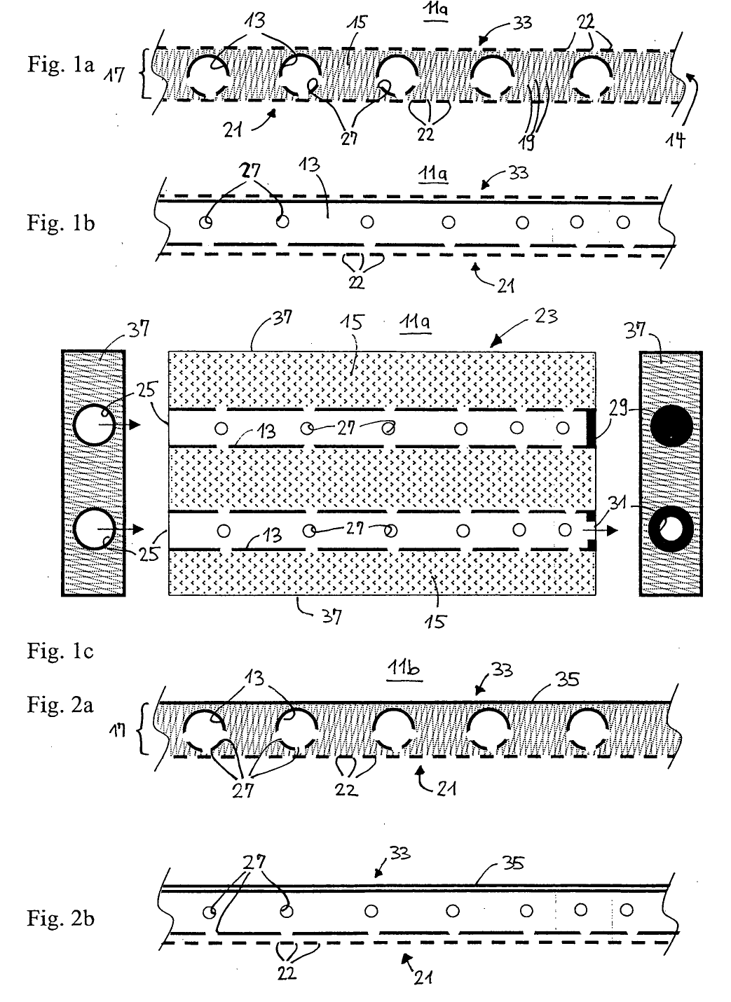

FIG. 1a shows a cross section through a first embodiment of an applicator in accordance with the invention with hoses accommodated in a three-dimensional structure permeable for gases;

FIG. 1b shows a longitudinal section along the line 1b-1b through the first embodiment of FIG. 1a;

FIG. 1c shows section along the line 1c-1c through the first embodiment of FIG. 1a, as well as elevations of the applicator as seen from the front and the rear;

FIG. 2a shows a cross section through a second embodiment of an applicator with an upper side that is not permeable for gases;

FIG. 2b shows a longitudinal section along the line 2b-2b through the second embodiment of FIG. 2a;

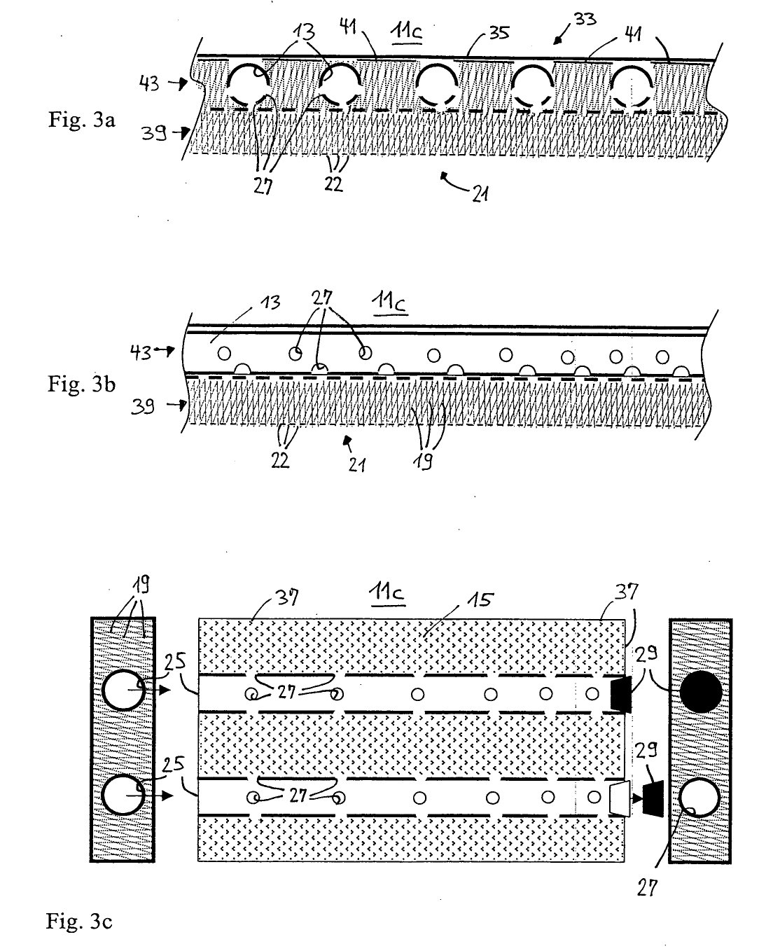

FIG. 3a shows a cross section though a third embodiment of an applicator with a three-dimensional structure consisting of several layers;

FIG. 3b shows a longitudinal section along the line 3b-3b through the third embodiment of FIG. 3a;

FIG. 3c a section along the line 3c-3c through the third embodiment of FIG. 3a and elevations of the applicator as seen from the front and the rear;

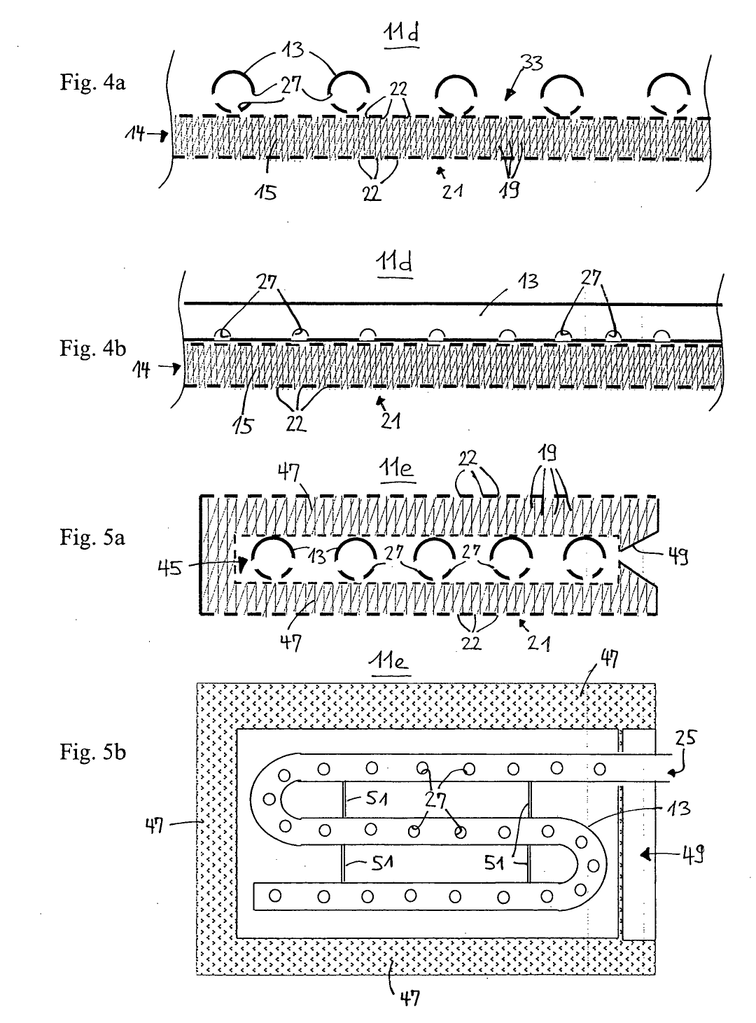

FIG. 4a shows a cross section through a fourth embodiment with gas distribution hoses arranged on the three-dimensional structure;

FIG. 4b shows a longitudinal section along the line 4b-4b through the fourth embodiment;

FIG. 5a a cross section through a fifth embodiment of an applicator in the form of a foldable pouch;

FIG. 5b shows a central section through the embodiment of FIG. 5a;

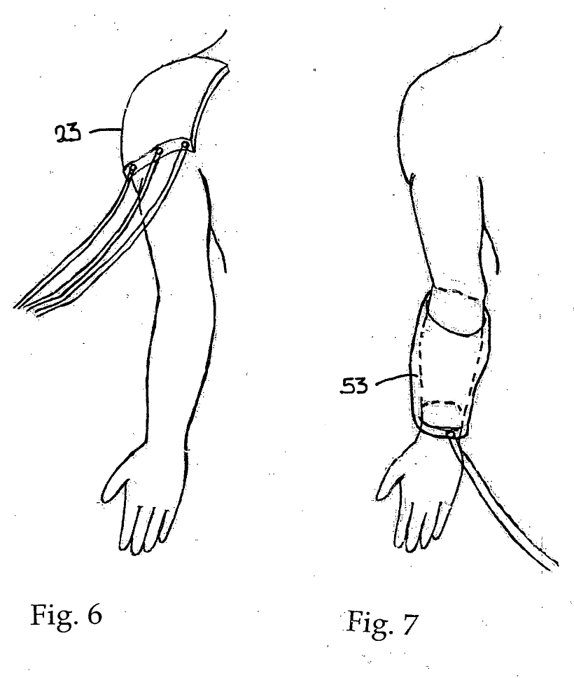

FIG. 6 shows the use of a cushion-shaped applicator on the shoulder of a patient;

FIG. 7 shows sleeve-like applicator placed around the forearm of a patient;

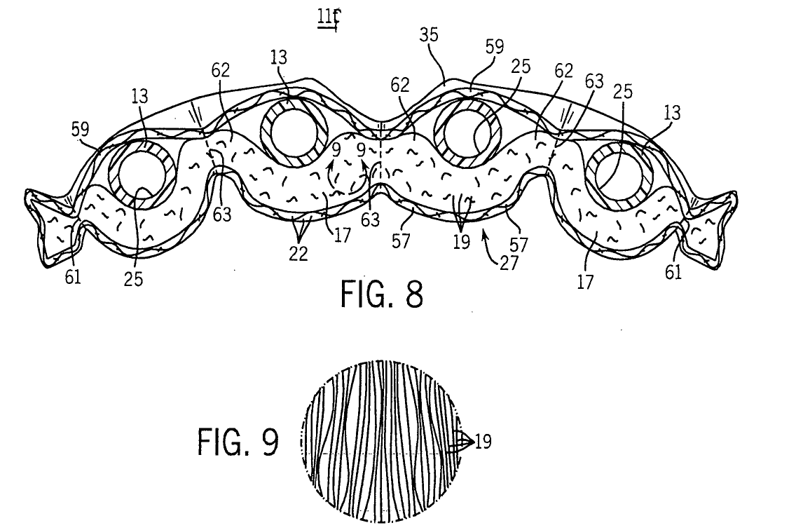

FIG. 8 shows a concrete embodiment of a cushion-shaped applicator with distribution hoses integrated in a three-dimensional fibre structure;

FIG. 9 shows a part of the three-dimensional fibre structure of the embodiment of FIG. 8 to a much larger scale;

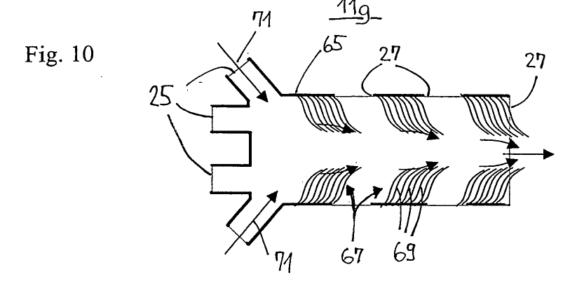

FIG. 10 schematically shows a tubular applicator with a brush attachment for the distribution of the gaseous medium.

The first embodiment of an applicator 11a in accordance with FIG. 1 is provided with several gas supply means in the form of hoses 13 that are arranged at a certain distance from each other and act together with gas distribution means 14 . The gas distribution means 14 have a three-dimensional structure 15 that is permeable for gases. The hoses 13 are accommodated in this three-dimensional structure 15. The three-dimensional structure 15 is preferably a textile woven or knitted spacer fabric in the form of a flat body. The knitted spacer fabric has a layer 17, a nonwoven fabric or a felt for example, that is permeable for gases in all directions. According to a preferred embodiment, the layer 17 is made of fibres or yarns 19. The fibres or yarns 19 define a plurality of through openings or channels oriented in all directions that assure a finely divided distribution of the gas issuing from the hoses during operation. The side of the three-dimensional structure that during application faces the body defines a gas passage side 21 (hereinafter also referred to as the underside or application side of the applicator). At least the gas passage side 21 may be made of a woven or knitted fabric of the second kind with which the three-dimensional woven or knitted spacer fabric is connected (see FIG. 8 and the description relating thereto). The gas passage side 21 is characterized by a plurality of through openings 22.

The applicator 11a is designed as, for example, a rectangular cushion 23. The hoses 13 are accommodated in the three-dimensional structure 15 and arranged at a certain distance from each other. Each of the hoses 13 has at least one inlet opening 25 and a plurality of outlet openings 27. The outlet openings 27 may be distributed over the entire circumference of the hose 13. It is also possible to provide the outlet openings 27 only along an oblong section and to orient the outlet openings 27 either at a right angle or at an acute angle with respect to the gas passage side 21. The outlet openings 27 may be arranged either at the same distance or at different distances from each other. Preferably, the distance from each other of the exist openings 27 will diminish as the distance from the gas inlet opening 25 increases, i.e. the outlet area per unit length will increase as a function of the distance from the gas inlet opening. Indeed, experiments have shown that this contributes to rendering the gas volume flow and the temperature distribution more even. The far end of the hose 13 may be closed with a stopper 29. It is also possible to substitute the stopper 29 with an adjustable valve 31, so that the gas volume flow may be set [to a desired value].

The embodiment 11b (FIG. 2) differs from the first by virtue of the fact that the side 33 opposite the gas passage side 21, i.e. the side of the applicator 11b that during operation faces away from the body (hereinafter also referred to as the rear side of the applicator), is a cover layer 35 impermeable for gases. It is also possible to provide the side edges 37 with a cover layer impermeable for gases, so that any gas entering the hoses 13 can leave them only through the gas passage side 21.

The embodiment 11c in accordance with FIG. 3 is distinguished by the fact that the three-dimensional structure consists of several layers. It has a continuous bottom layer 39 on which the hoses 13 are arranged at a certain distance from each other. The bottom layer 39 is preferably a three-dimensional woven or knitted spacer fabric 15 as already described hereinabove. Strips 41 of another spacer material are provided between the hoses 13. The hoses 13 and the strips 41 arranged between them define an upper layer 43. A cover layer 35 impermeable for gases, as in the second embodiment, may be arranged on the upper layer 43. It can clearly be seen that the distance between the outlet openings 27 becomes continually smaller as the end of the hose is approached.

Embodiment 11d (FIG. 4) differs from the one of FIG. 3 by virtue of the fact that the hoses 13 are merely arranged at a certain distance from each other on the structure 15 consisting of a three-dimensional woven or knitted spacer fabric and that no further layers or a cover layer impermeable for gases are provided. Outlet openings 27 are provided solely on the lower half of the hoses 13. The outlet openings 27 are oriented at an angle with respect to the upper side of the woven or knitted spacer fabric. The hoses 13 may be arranged on the upper side of the three-dimensional woven or knitted spacer fabric by means of removable or non-removable fixing means that are not shown in detail in the figure.

FIG. 5 illustrates another multi-layer embodiment 11e in which the gas supply means 13 define an inner layer 45 that is surrounded in the manner of a sandwich by two layers 47 of a three-dimensional textile woven or knitted spacer fabric. The applicator 11e may be designed as a hinged and openable pouch with a window 49. It is therefore possible for the interior parts of the applicator to be substituted at any time. The hoses 13 may be single pieces and arranged in the inner layer 45 in the manner of meanders. (FIG. 5b). Distance pieces 51 fix the position of the hoses with respect to each other.

FIGS. 6 and 7 illustrate concrete embodiments and application examples of the applicator in accordance with the invention. FIG. 6 shows an applicator 11 designed as a cushion 23 placed over the shoulder of a person. A cold or heated gaseous medium can be applied to the part of the body in question via the hoses 13.

FIG. 7 shows an applicator in the form of a sleeve 53 placed around the forearm of the person to be treated.

The applicator 11f in accordance with FIG. 8 is provided with a layer 17 that consists of fibres, serves to obtain a finely divided gas distribution and is arranged on a permeable woven or knitted fabric 57. The woven or knitted fabric 57 has a large-size mesh and constitutes the gas passage side 21 with through openings 22. The fibres 19 of the layer 17 are preferably arranged either substantially orthogonal or at an angle with respect to the outlet side 21, so that a loose and compressible three-dimensional structure is formed. Preferably, the layer 17 consist of meshes that are intertwined with each other.

The rear side 33 of the applicator I If formed by a permeable woven or knitted fabric 59 that, at least at the circumference, is connected with the woven or knitted fabric 57, by means of a seam 61 for example. The woven or knitted fabric 59 is covered by an impermeable layer 35, a plastic foil for example. The woven or knitted fabrics 57, 59 may be made of the same material and produced in the same manner.

Flexible plastic hoses 13 are arranged at a certain distance from each other on the layer 17. A nonwoven material or a woven or knitted fabric 61, preferably likewise permeable for gases, is applied between the hoses 13. Just like the layer 17, the material 62 may consist of a loose fibre arrangement. The hoses 13 are covered by the woven or knitted fabric 59 and fixed in their position by means of longitudinal seams 63 provided between the hoses.

FIG. 8¹ schematically illustrates a tubular embodiment 11g of an applicator in accordance with the invention. The applicator 11g comprises a tube 65 with several inlet openings 25 and an outlet opening 27. An extremity, an arm for example, can be inserted in the applicator through the gas outlet opening 27. On the inner surface of the tube there is provided a brush attachment 67 made up of preferably elastic bristles 69 that project either orthogonally or at an angle from the interior surface of the tube. During operation the bristles 69 are in contact with the surface of the skin and the gas flowing in from the inlet openings 25 (Arrow 71) becomes finely divided by the bristles 69.

The applicator and/or the applicator system may be utilized for the controlled distribution and/or dosage of cold air or cold and/or warm air or warmth to limited surfaces and/or volumes in the case of all illnesses and conditions that are either directly or indirectly connected with spastics, oedemas, circulatory problems, as well as variations of the tension, length, structural, biomechanical, neurogenous, metabolic and viscous characteristics in the cellular, histological, organic, genetic and physiological area, especially of the musculature, the ligaments, the bones and the vascular and nervous system of living beings. Advantageously, the applicator system may be used for the treatment of circulatory problems in the cardiac-circulatory system. A further application concerns the use of the applicator in accordance with the invention for mobilizing the muscular and neuromuscular sector and the respiration and improving their performance. One can also imagine the applicator being used for the positive stimulation of the immune system and the psycho-vegetative system.

The application leads to a mobilization and performance improvement of the neuromuscular system and the vascular system, as also to a favourable conditioning and/or improvement of the biomechanical, neuro-physiological and metabolic qualities of the musculature and the ligaments, the entire supporting and locomotor system, inclusive of all other histological structures. A positive influence is exerted on the hormonal, endocrinal, circulatory and microcirculatory aspects of the body and/or the body area. The criteria for the prevention and/or elimination of oedemas are also positively influenced. The haemodynamic, viscous and circulatory aspects of the body fluids are improved.

The applicators described hereinabove are employed as follows: flat or tubular applicators are placed on the part of the body that is to be treated and a heated or cooled gaseous medium is then passed through them. Passing through connection lines, the medium cooled or warmed by means of an {appropriate] cooling or warming device reaches the gas distribution spaces provided in or on the applicator. Through the outlet openings provided in the gas distribution spaces the medium reaches the three-dimensional structure, which is essentially permeable for gases in all directions, especially also parallel to the gas passage side. Due to the three-dimensional structure, the issuing medium becomes finely distributed while still in the applicator and thereafter reaches the environment of the part of the body to be treated and/or the part itself through the through openings on the gas passage side.

The gaseous medium can be selectively supplied either through selected or all gas inlet openings. It is possible for the medium to be circulated and the temperature of the medium to be regulated by means of a heating or cooling circuit. Consequently, cold and/or warm medium can be made to pass over the part of the body to be treated and/or several different parts of the body under all the possible execution modes interchangeably, alternatively, at different times or at one and the same time. This makes it possible, for example, for an agonistic muscle to be cooled and the antagonistic muscle to be warmed. Synergistic and/or antagonistic muscle chains may be treated with cold or heat exactly as needed. In particular, with the applicator it becomes possible to form two or more spaces that are separated from each other and from the environment and then pass any desired medium flows through them in accordance with any desired timing schedules.

Advantageously, both the quantity and the temperature of the supplied and applied medium will be measured, whenever necessary calculating also the applied quantity of heat. This has the advantage that treatments can be readily controlled and reproduced. In particular, it is possible for the surface temperature of the body and, whenever necessary, also the pressure prevailing in the application to be measured with the help of one sensor in each case, so that both the temperature and the pressure of the gaseous medium can be appropriately set. A control circuit may be provided in order to render possible an efficacious treatment. The measures that have just been described make it possible to record that quality and the quantity of the medium and their effect on the body.

The use of the applicators of the new type makes it possible to obtain an effect coupling and/or synergy due to the simultaneous employment of active and passive applications. The applicators can be adapted and brought into line with the special requirements of the body, the thermodynamics and the proposed application. They can be combined and used together with any measuring, control and regulating device to assure effective use and application of the mediums

An applicator 11a-g for the application of a gaseous medium to the surface of a part of the body of a live human or animal organism has a three-dimensional structure with a gas passage side 21 with a plurality of through openings 22. When in use, the gas passage side 21 faces the part of the body that is to be treated or, preferably, is in contact therewith. Furthermore, there is provided a device 13 for leading a gas or gas mixture to or onto the gas passage side, which is so designed as to assure that at least a part of the gas supplied during the operation of the applicator will flow through or to the through openings 22 on the gas passage side 21. A three-dimensional structure 15 provided on the gas passage side 21 assures that the medium issuing from the gas passage side 21 will have an even temperature and volume distribution. The three-dimensional structure assuring gas distribution will preferably have a thickness of at least 3 mm, preferably between 3 and 30 mm, and even more preferably between 5 and 20 mm.

Legend:

11 Applicator

13 Gas supply means, for example hoses, cushions

15 Three-dimensional structure, for example, a textile woven or knitted spacer fabric

17 Layer of the three-dimensional structure consisting of yarns or fibres

19 Yarns or fibres of the three dimensional structure

21 Gas passage side of the three-dimensional structure

22 Through openings of the gas passage side of the three-dimensional structure

23 Cushion

25 Inlet opening of the gas supply and distribution means, hoses for example

29 Stopper

31 Adjustable valve

33 Side of the applicator facing away from the body (=rear side)

35 Layer impermeable for gases

37 Side edges

39 Lower layer of the multi-layer embodiment 11c

41 Strips of the upper layer 43

43 Upper layer

45 Lower layer made up of hoses

47 Layers made of a three-dimensional woven or knitted fabric or nonwoven material

49 Opening of the applicator 11e

51 Distance piece

53 Applicator sleeve

57, 59 Tissue or fabric

61 Seam at the outer edge

62 Nonwoven material, woven or knitted fabric

63 Longitudinal seams parallel with the hoses

67 Brush attachment

69 Bristles

71 Direction of flow of the gaseous medium during operation

1. An applicator for the application of a cooled or warmed gaseous medium to a part of the body of the living human or animal organism with
a flexible gas passage means designed as a flat body and defining a plurality of through openings with a first side defining a gas passage side that faces the part of the body to be treated when the applicator is in use, and
a device for supplying a gas or gas mixture to or onto the gas passage means with at least one distribution space that extends in the region of the gas passage means designed as a flat body and is provided with a plurality of gas outlet openings, which are arranged at a certain distance from the gas passage side,
characterized in that
the gas passage means is a three-dimensional woven or knitted spacer fabric of a first kind that is permeable for gases and is made of fibres or yarns, the fabric defining a plurality of gas passage openings or gas passage channels oriented in all directions, so that gas distribution is assured both parallel to the gas passage surface and at right angles thereto during operation.

2. An applicator in accordance with claim 1, characterized in that the three-dimensional structure is a three-dimensional woven or knitted spacer fabric.

3. An applicator in accordance with claim 2, characterized in that the three-dimensional woven or knitted spacer fabric is made of a material that absorbs and/or removes moisture.

4. An applicator in accordance with claim 1, characterized in that the device for supplying a gas defines at least one distribution space that is provided with a plurality of outlet openings.

5. An applicator in accordance with claim 5, characterized in that the at least one distribution space extends in the region the gas passage means designed as a flat body.

6. An applicator in accordance with claim 4, characterized in that there are provided several distribution spaces arranged at a certain distance from each other.

7. An applicator in accordance with claim 4, characterized in that the distribution space is a hose, a tube, a bag or something similar.

8. An applicator in accordance with claim 4, characterized in that the at least one distribution space is provided with a plurality of outlet openings.

9. An applicator in accordance with claim 1, characterized in that the outlet openings are oriented at least in the direction of the gas passage sided.

10. An applicator in accordance with claim 1, characterized in that the applicator is designed to be flexible, so that the applicator may be adapted to and/or be placed against different parts of the body.

11. An applicator in accordance with claim 1, characterized in that the gas supply device is arranged in or on the three-dimensional structure.

12. An applicator in accordance with claim 1, characterized in that the applicator has a second side, preferably impermeable for gases, lying opposite the first gas passage side, and that the gas distribution spaces are preferably arranged between the first and the second side.

13. An applicator in accordance with claim 1, characterized in that the three-dimensional structure consists of several layers.

14. An applicator in accordance with claim 1, characterized in that the outlet openings of the gas supply y device are arranged at a certain distance from the gas passage side of the three-dimensional structured.

15. An applicator in accordance with claim 1, characterized in that the distribution space is provided with guide surfaces to orient the gas medium issuing during operation of the applicator in direction of the gas passage side.

16. An applicator in accordance with claim 1, characterized in that the applicator is provided with fixing means for attaching the applicator to or above the part of the body that is to be treated.

17. An applicator in accordance with claim 16, characterized in that the fixing means, for example a strap, a belt or similar, are integral with the applicator.

18. An applicator in accordance with claim 1, characterized in that the applicator is essentially designed as a flat body, in the form of a cushion for example.

19. An applicator in accordance with claim 1, characterized in that the applicator has the form of a sleeve that can be placed over an extremity of the body.

20. An applicator in accordance with claim 1, characterized in that the applicator is provided with at least one window in the gas passage means.

21. An applicator system with at least one cooling and/or heating device for the production of a cooled or heated gaseous medium and an applicator in accordance with claim 1, as well as, whenever necessary, connection means to connect the cooling/heating device to the applicator.
